(19) United States
(12) Patent Application Publication
(10) Pub. No.: US 2010/0125909 A1
(43) Pub. Date: May 20, 2010

(54) MONITOR DEVICE, MONITORING METHOD AND COMPUTER PROGRAM PRODUCT THEREOF FOR HARDWARE

(75) Inventors: Shih-Yao DAI, Taipei City (TW); Chih-Hung LIN, Zhonghe City (TW); Yen-Nun HUANG, Taipei City (TW); Chia-Hsiang CHANG, Taipei City (TW); Sy-Yen KUO, Taipei City (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: INSTITUTE FOR INFORMATION INDUSTRY, Taipei (TW)

(21) Appl. No.: 12/419,048

(22) Filed: Apr. 6, 2009

(30) Foreign Application Priority Data
Nov. 17, 2008 (TW) 097144331

(51) Int. Cl. G06F 12/14; G06F 9/44

(52) U.S. Cl. 726/22; 712/220

(57) ABSTRACT

A monitor device, a monitor method and a computer program product thereof for hardware are disclosed. The hardware comprises a central processing unit (CPU) and a storage module. The monitor device comprises a retrieval module and an analysis module. The retrieval module is configured to retrieve the entry point information of a process before the process is executed, wherein the process comprises at least one instruction from the hardware. The analysis module is configured to retrieve an address corresponding to the process according to the entry point information. When the CPU executes the at least one instruction, the storage module records the at least one instruction according to the address.

This application claims the benefit of priority based on Taiwan Patent Application No. 097144331 filed on Nov. 17, 2008, the disclosures of which are incorporated herein by reference in their entirety.

### CROSS-REFERENCES TO RELATED APPLICATIONS

Not applicable.

### BACKGROUND OF THE INVENTION

1. Field of the Invention

The present invention relates to a monitor device, a monitor method and a computer program product thereof for hardware. More particularly, the present invention relates to a monitor device, a monitor method and a computer program product thereof capable of protecting hardware and software, which is executed on it from being attacked by malicious processes.

2. Descriptions of the Related Art

With the development of the information technology (IT) industry, computers and networks have become indispensable in daily life. For example, computers have been used for processing various data, searching different kinds of information, shopping online and exchanging data. Furthermore, network services, such as checking by e-credit cards, shopping over the Internet and web ATM service, are also frequently used.

However, because users have relied more on computers and the Internet, there is a higher chance for malware to invade the users' computers. For example, a USB mobile disk, infrared rays or Bluetooth connection, malware is able to steal or destroy important information stored within computers via the Internet, or even restrict the authority of users' computers through controlling their computer systems. Additionally, malware may not only be bothersome with its advertisement or spam software instilled on the computers, but also waste Internet resources. Therefore, the security of computers and networks is a topic of great importance.

To protect computers from being disrupted by malware in various manners described above, a conventional practice provides an antivirus program to keep the malware from accessing or disrupting the users' computers. Malware features are built by a malware analysis tool, and according to these features, the antivirus program is able to detect and prevent disruption from the malware. More specifically, CWSandbox (a malware analysis tool) can analyze different types of malware to build the corresponding malware features, and then Kaspersky (an antivirus program) can detect and prevent disruption from the malware according to the malware features.

However, both the antivirus programs and malware analysis tools are installed in the operation system of a computer and operates in the same way as the malware, i.e., operates via the operation system. More specifically, the antivirus programs or malware analysis tools operates in the same environment (and via the same operation system) as the malware. In other words, if the malware detects that it is in an environment where an antivirus program or malware analysis tool is running, the malware may further disrupt the operation of the antivirus program or malware analysis tool. Alternatively, the malware may execute the instructions of other normal programs to misguide the antivirus program or malware analysis tool to collect the wrong information. Therefore, the ability of the antivirus program is considerably restricted due to using the same operation system as the malware.

Accordingly, with the increasingly flooding malware, it is important to provide a monitoring method that is not operated in the operation system and being detected by the malware.

### SUMMARY OF THE INVENTION

An objective of this invention is to provide a monitor device for hardware. The hardware comprises a central processing unit (CPU) and a storage module. The monitor device comprises a retrieval module and an analysis module. The retrieval module is configured to retrieve the entry point information of a process from the storage module before the process is executed, wherein the process comprises at least one instruction. The analysis module is configured to retrieve an address corresponding to the process from the CPU according to the entry point information, wherein the address corresponds to a memory block storing the at least one instruction. When the CPU executes the at least one instruction, the storage module records the at least one instruction of the process according to the address.

Another objective of this invention is to provide a monitor method. The monitor method comprises the following steps: (1) retrieving the entry point information of a process before it is executed, wherein the process comprises at least one instruction; (2) retrieving an address corresponding to the process according to the entry point information, wherein the address corresponds to a memory block storing the at least one instruction; (3) executing the at least one instruction; and (4) recording the at least one instruction of the process according to the address, wherein the hardware retrieves the entry point information and records the at least one instruction of the process according to the address.

Yet a further objective of this invention is to provide a computer program product having a computer program stored thereon for enabling a microprocessor to execute the monitor method described above.

In summary, the monitor device, the monitor method and the computer program product thereof for hardware disclosed in this invention are able to monitor all the processes that are executed in the hardware. For the hardware, when the computer is executing the instructions of the processes, the instructions will be recorded and analyzed according to the respective corresponding addresses. In this way, this invention can detect malware according to an address corresponding to the instruction(s) thereof without the support of the operation system, thereby overcoming the drawbacks of the prior art. Meanwhile, by detecting the malware through the above method, this invention can also safeguard the critical sections (e.g. the memory section) of the computer to prevent unexpected results (e.g. skipping an authentication process, control hijacking, and etc) of processes executed in the critical sections due to the disruption caused by the malware.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a first embodiment of this invention; and

FIG. 2 is a flowchart of a second embodiment of this invention.

### DESCRIPTION OF THE PREFERRED EMBODIMENT

This invention provides a monitor device, a monitor method and a computer program thereof for hardware. The advantages of this invention are that the monitor device can be undetected by malicious process, while the higher level program language information can also be analyzed in the hardware. It should be noted that, a “program” is defined as a file that is executable when being loaded, while a “process” is defined as a program that is being executed. However, for simplicity, a program that is about to be executed is also called a process in this invention. The following embodiments are provided only for purpose of illustration, but not to limit this invention. In the following embodiments and attached drawings, elements unrelated to this invention are omitted from depiction.

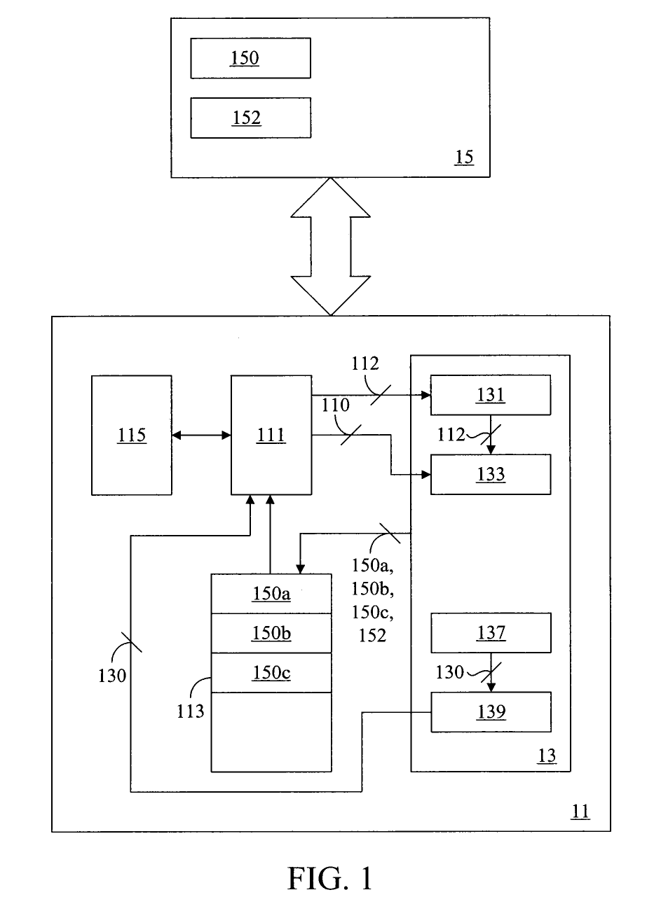

As shown in FIG. 1, a first embodiment of this invention is a monitor device 13 for hardware 11. The hardware 11 comprises a CPU 111 and a memory 113. A user controls elements of the hardware 11 through an operation system 15. The operation system 15 may be one of various commercially available operation systems, for example, Windows operation systems, Macintosh operation systems, Linux operation systems or Unix operation systems. In the first embodiment, the operation system 15 is a Windows operation system. The hardware 11 may be a personal computer (PC) or an Apple Macintosh (MAC). The hardware 11 is a PC in the first embodiment. It should be appreciated that the types of the operation system 15 and the hardware 11 are not limited in this invention, and those of ordinary skill in the art may practice this invention with other types of operation systems, hardware and combinations thereof. Thus, this will not be further described herein.

The monitor device 13 comprises a retrieval module 131, an analysis module 133, a determination module 137 and an interception module 139. When prepared to execute a process 150, the operation system 15 assigns an address (e.g. a CR3 value 110) to the process 150 and records the address in a register of the CPU 111, so that the operation system 15 and the hardware 11 can execute instructions or a system call corresponding to the process 150 according to the CR3 value 110. Because the process 150 is assigned to the address, the operation system 15 generates entry point information 112, e.g. a flag, a signal or a memory address, to indicate that the process 150 is going to be executed.

After the retrieval module 131 of the monitor device 13 has retrieved the entry point information 112, the analysis module 133 retrieves the CR3 value 110 corresponding to the process 150 to be executed from the CPU 111 according to the entry point information 112.

The process 150 comprises of a plurality of instructions (e.g. instructions 150a, 150b and 150c) for accomplishing a particular task, for example, recording a file, editing a document, etc. All these instructions 150a, 150b and 150c have the same CR3 value 110 as the process 150. The instructions 150a, 150b and 150c of the process 150 are stored in the memory 113 of the hardware 11. The particular task may be accomplished not only though the instructions 150a, 150b and 150c of the process 150, but also through various system calls 152 stored in the operation system 15.

In this embodiment, the process 150 is a portable executable (PE) file. The PE file is a 110 standard PE format of the operation system 15, e.g., a format of an executable (exe) file or a dynamic link library (DLL) file of the Microsoft operation system or the like. The system call 152 may be a Win32 system call or a native system call. Similarly, the system call 152 also has the same CR3 value 110 as the process 150. The composition of the process 150 will be readily appreciated by those of ordinary skill in the art based on existing technical documents and his own knowledge, and thus will not be further described herein.

Once execution of the process 150 commences, the CPU 111 will retrieve the instructions 150a, 150b and 150c from the memory 113 for processing. The instructions 150a, 150b and 150c have the same CR3 value 110 as the process 150, so when the instructions 150a, 150b and 150c are being processed, the monitor device 13 records the instructions in the memory 113 of the hardware 11 according to the CR3 value 110 thereof. On the other hand, when the CPU 111 retrieves the system call 152 corresponding to the process 150 from the operation system 15 for processing, the monitor device 13 also records the system call 152 in the memory 113 of the hardware 11 according to the CR3 value 110 thereof.

When the execution of the process 150 is in progress or has been finished, the determination module 137 of the monitor device 13 will retrieve all instructions 150a, 150b and 150c as well as the system call 152 that have been executed by the process 150 from the memory 113, and compare the instructions 150a, 150b and 150c as well as the system call 152 that have been executed with a malicious process behavior model (not shown) to determine whether the process 150 is a malicious process.

If the process 150 that is in progress or has been finished is determined to be a malicious process because it matches the malicious process behavior model, the interception module 139 of the monitor device 13 will send a closing signal 130 to the CPU 111 to close the process 150 that has been identified as a malicious process. More specifically, if one of the instructions of the process 150 (e.g. the instruction 150b) or the system call 152 thereof is accessing a critical section 115 of the hardware 11 in the CPU 111, the interception module 139 of the monitor device 13 will send a closing signal 130 to the CPU 111 to close the process 150 that has been identified as a malicious process, thereby preventing the process 150 from accessing the critical section 115 of the hardware 11.

This embodiment mainly utilizes the monitor device 13 to record and collect the instructions and system call processed by the CPU 111 while the process 150 is executed to derive a behavior model of the process 150. The monitor device 13 compares the behavior model of the process 150 against a malicious process behavior model afterwards. If the behavior model of the process 150 is similar to the malicious process behavior model, then there is a high probability that the process 150 is a malicious process. In response to this, the monitor device 13 may proceed to intercept the process 150 that is identified as a malicious process to protect the data stored in the elements of the hardware.

This invention has no limitation on the scope of the critical sections 115 of the hardware 11, and the critical sections 115 may be a program counter (PC) associated with the execution sequence, a translation lookaside buffer (TLB) associated with the virtual address code translation, or other sections of the hardware that would cause the abnormal operation of the hardware 11 while being modified or disrupted. The critical sections 115 of the hardware 11 may be defined by those of ordinary skill in the art, and thus will not be further described herein.

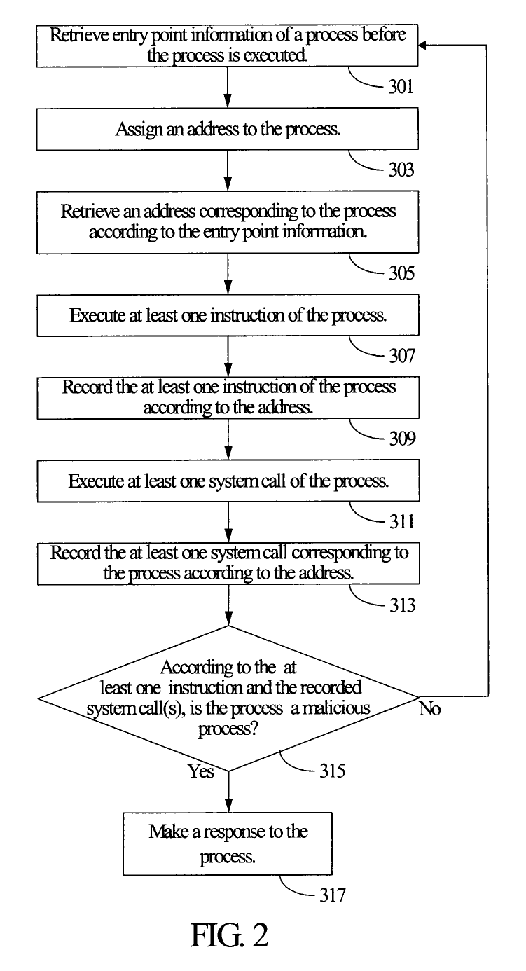

FIG. 2 is a second embodiment of this invention, which is a monitor method. The monitoring method is adapted for a monitor device, for example, the monitor device 13 described in the first embodiment. More specifically, the monitor method of the second embodiment may be implemented by a computer program product. When the computer program product is loaded in a microprocessor and a plurality of codes thereof is executed, the monitor method of the second embodiment can be accomplished. This computer program product may be stored in a tangible machine-readable medium, such as a read only memory (ROM), a flash memory, a floppy disk, a hard disk, a compact disk, a mobile disk, a magnetic tape, a database accessible to networks, or any other storage media with the same function and well known to those skilled in the art.

The monitor method of the second embodiment comprises the following steps. Initially in Step 301, the entry point information of a process comprising at least one instruction is retrieved before the process is executed. Then, an address is assigned to the process in Step 303. Next, in Step 305, an address corresponding to the process is retrieved according to the entry point information. The at least one instruction corresponding to the process is executed in Step 307, and the at least one instruction corresponding to the process is recorded according to the address in Step 309.

In Step 311, at least one system call corresponding to the process is executed. Next, in Step 313, the at least one system call corresponding to the process is recorded according to the address. In Step 315, the process is determined whether it is malicious according to the at least one instruction and the recorded system call(s). If it is, then a response is made to the process in Step 317. Otherwise, if the process is not malicious, Steps 301 through 315 are repeated to determine whether any other process is a malicious process.

In summary, this invention directly monitors the instructions of a process executed by the CPU in hardware. For the hardware, when the user is executing an instruction or a system call of the process, the instruction and system call will be recorded and analyzed according to a corresponding address thereof. In this way, this invention can detect malware according to the address corresponding to the instruction(s) without the support from the operation system, thereby overcoming the drawback of the prior art.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A monitor method, comprising the steps of:
retrieving entry point information of a process before the process is executed, wherein the process comprises at least one instruction;
retrieving an address corresponding to the process according to the entry point information, wherein the address corresponds to a memory block where the at least one instruction is stored;
executing the at least one instruction of the process; and
recording the at least one instruction of the process according to the address;
wherein hardware retrieves the entry point information and records the at least one instruction of the process according to the address.

2. The monitor method of claim 1, further comprising:
assigning the address to the process.

3. The monitor method of claim 1, wherein the entry point information is a processor flag.

4. The monitor method of claim 1, further comprising:
executing at least one system call corresponding to the process; and
recording the at least one system call according to the address.

5. The monitor method of claim 4, wherein the at least one system call is one of a win32 system call and a native system call.

6. The monitor method of claim 1, further comprising:
determining the process to be a malicious process according to the at least one instruction of the recorded process; and
making a response to the process.

7. A computer program product storing a program for a microprocessor to perform a monitor method, the program comprising:
a first instruction, enabling the microprocessor to retrieve entry point information of a process before the process is executed, wherein the process comprises at least one instruction;
a second instruction, enabling the microprocessor to retrieve an address corresponding to the process according to the entry point information, wherein the address corresponds to a memory block where the at least one instruction is stored;
a third instruction, enabling the microprocessor to execute the at least one instruction of the process; and
a fourth instruction, enabling the microprocessor to record the at least one instruction of the process according to the address.

8. The computer program product of claim 7, wherein the program further comprises:
a fifth instruction, enabling the microprocessor to assign the address to the process.

9. The computer program product of claim 7, wherein the entry point information is a processor flag.

10. The computer program product of claim 7, wherein the program further comprises:
a fifth instruction, enabling the microprocessor to execute at least one system call corresponding to the process; and
a sixth instruction, enabling the microprocessor to record the at least one system call according to the address.

11. The computer program product of claim 10, wherein the at least one system call is one of a win32 system call and a native system call.

12. The computer program product of claim 7, wherein the program further comprises:
a fifth instruction, enabling the microprocessor to determine the process to be a malicious process according to the at least one instruction of the recorded process; and
a sixth instruction, enabling the microprocessor to make a response to the process.

13. A monitor device for hardware, the hardware comprising a central processing unit (CPU), a storage module and a critical section, the monitor device comprising:
a retrieval module, being configured to retrieve entry point information of a process from the storage module before the process is executed, wherein the process comprises at least one instruction; and
an analysis module, being configured to retrieve an address corresponding to the process from the CPU according to the entry point information, wherein the address corresponds to a memory block storing the at least one instruction;
wherein, the storage module of the hardware records the at least one instruction of the process according to the address when the CPU executes the at least one instruction of the process.

14. The monitor device of claim 13, wherein an operation system assigns the address to the process.

15. The monitor device of claim 13, wherein the entry point information is a processor flag.

16. The monitor device of claim 13, wherein the storage module of the hardware records the at least one system call according to the address when the CPU executes at least one system call corresponding to the process.

17. The monitor device of claim 16, wherein the at least one system call is one of a win32 system call and a native system call.

18. The monitor device of claim 13, further comprising:
a determination module, being configured to determine the process to be a malicious process according to the at least one instruction of the process recorded by the storage module of the hardware; and
an interception module, being configured to make a response to the process.
